(19) United States
(12) Patent Application Publication
(10) Pub. No.: US 2013/0286386 A1
(43) Pub. Date: Oct. 31, 2013

(54) OPTICAL SURFACE DEFECT INSPECTION APPARATUS AND OPTICAL SURFACE DEFECT INSPECTION METHOD

(71) Applicant: HITACHI HIGH-TECHNOLOGIES CORPORATION, Tokyo (JP)

(72) Inventors: Shigeru SERIKAWA, Kamisato-machi (JP); Toshiaki SUGITA, Kamisato-machi (JP); Keiji KATO, Kamisato-machi (JP); Fariz bin ABDULRASHID, Kamisato-machi (JP)

(73) Assignee: HITACHI HIGH-TECHNOLOGIES CORPORATION, Tokyo (JP)

(21) Appl. No.: 13/865,406

(22) Filed: Apr. 18, 2013

(30) Foreign Application Priority Data
Apr. 25, 2012 (JP) 2012-099877

(51) Int. Cl. G01N 21/95; G01N 21/956

(52) U.S. Cl. CPC G01N 21/9501; G01N 21/956
USPC 356/237.5; 356/237.2

(57) ABSTRACT

The invention provides an optical surface defect inspection apparatus and an optical surface defect inspection method that reduces an influence from a dead zone of a sensor array and that reduces the influence from reduction of a detected light amount in a case of extending over light receiving elements, thereby enabling a defect inspection with high sensitivity. According to the invention, a subject is irradiated with an inspection light, an image is formed on the sensor array including the light receiving elements separated by the dead zone insensitive to light scattered by a surface of the subject and arranged in a plurality of lines, outputs from two adjacent light receiving elements are added, and a defect on the surface of the subject is inspected for based on the result of the addition.

### FIELD OF THE INVENTION

The present invention relates to an optical surface defect inspection apparatus and an optical surface defect inspection method, specifically to the optical surface defect inspection apparatus and the optical surface defect inspection method suitable for detecting a microdefect formed on a surface of a subject.

### BACKGROUND ART

Both a high-speed inspection applicable to 100% full inspection and a highly sensitive inspection are required for an optical surface defect inspection apparatus that inspects for a microdefect on a surface of a subject such as a magnetic disc, a glass or aluminum substrate used as a substrate thereof, and an IC wafer. It is especially required to inspect for a linear microdefect (scratch), which does a significant damage to a product. A highly sensitive defect detection generally employs a method of irradiating the surface with a microspot with a high intensity and scanning the surface therewith, thereby detecting a scattered light from the defect on the surface with high sensitivity. Moreover, for the high-speed inspection, the whole scanning must be completed in a short time by employing a rough scanning pitch, and the size of the irradiation spot in this case must be suitable to at least sufficiently cover the scanning pitch. However, there is a trade-off that a large spot size will result in a lower spot intensity and thus a lower detection sensitivity.

One method of performing such a highly sensitive and high-speed surface defect inspection is disclosed in Japanese Patent LAID-Open 2001-174415. This technology includes a light transmitting system that emits a light beam having a width in a direction perpendicular to a main scanning direction and relatively scans a face plate, a light receiving system that includes a sensor array having n (n is an integer larger than one) light receiving elements arranged in perpendicular directions and receiving lights reflected by the face plate and forms an image of scanned position on the face plate on the n light receiving elements, a stripe pattern filter that reverses relation of transmission and shielding of adjacent light receiving elements substantially on the right side and the left side from the center of a light receiving surface of the light receiving elements, and a detection circuit that generates a detection signal corresponding to a difference in the received light amount between the adjacent light receiving elements as a signal for detecting a defect, wherein data acquired from the n light receiving elements is processed to detect a microdefect. The technology of Japanese Patent LAID-Open 2001-174415 is intended for defects from which the detection signal is available with respect to an area of approximately one light receiving element at the smallest.

### SUMMARY OF THE INVENTION

However, demands for the highly sensitive detection are growing still severer in these days. There is a dead zone between light receiving elements in a sensor array in which a plurality of light receiving elements are arranged in series (actually about 100 of the width of a single light receiving element). There is a problem that the dead zone reduces the detected light amount of the scattered light, thereby reducing the detection sensitivity. The reduction of the detection sensitivity greatly affects the size of the defect that can be detected at the width of a single light receiving element. There is another problem that, when the scattered light from the defect extends over two light receiving elements, the detected light amount is distributed to both elements, thereby reducing the detected light amount.

The present invention was made in the light of the above problems, and aims to provide the optical surface defect inspection apparatus and the optical surface defect inspection method that reduces the influence from the dead zone of the sensor array and reduces the influence from reduction of the detected light amount in the case of extending over the light receiving elements, thereby enabling the defect inspection with high sensitivity.

To achieve the above objectives, the present invention has at least the following features.

The apparatus according to the invention includes: an irradiation means irradiating a subject with an inspection light; a sensor array including light receiving elements separated by dead zones insensitive to light scattered by a surface of the subject and arranged in a line; a scattering optical means light focusing the scattered light onto the sensor array; a plurality of addition means adding outputs from two adjacent the light receiving elements; and a processing unit inspecting for a defect on the surface of the subject based on outputs from the addition means.

The method according to the invention includes: an irradiation step of irradiating a subject with an inspection light; a step of forming an image on a sensor array including light receiving elements separated by dead zones insensitive to light scattered by a surface of the subject, the receiving elements being arranged in a line; a plurality of addition steps of adding outputs from two adjacent light receiving elements; and a processing step of inspecting for a defect on the surface of the subject based on the result of the addition step.

The present invention can provide an optical surface defect inspection apparatus and an optical surface defect inspection method that reduces the influence from the dead zone of the sensor array and reduces the influence from reduction of the detected light amount in the case of extending over the light receiving elements, thereby enabling the defect inspection with high sensitivity.

### BRIEF DESCRIPTION OF THE DRAWINGS

FIG. 1 shows an embodiment of an optical surface detect inspection apparatus according to the invention;

FIG. 2 is an illustration of a mechanism and operation of scanning a whole surface of a subject by spiral scanning;

FIG. 3A shows a configuration of a sensor array according to the embodiment and a relation between the sensor array and the subject;

FIG. 3B shows the configuration of the sensor array according to the embodiment and a configuration of a preprocessing unit of the sensor array;

FIG. 4A shows a configuration of a conventional sensor array and a relation between the conv. sensor array and the subject;

FIG. 4B shows the configuration of the conventional sensor array and a configuration of a preprocessing unit of the conventional sensor array; and

FIG. 5 shows a general configuration of the preprocessing unit according to the embodiment.

### DESCRIPTION OF THE PREFERRED EMBODIMENTS

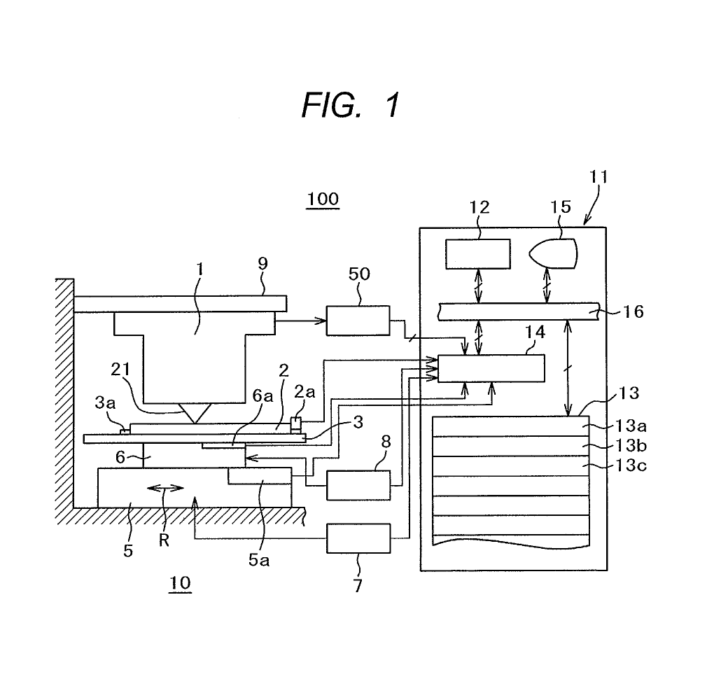

FIG. 1 shows an embodiment of an optical surface defect inspection apparatus (hereinafter, referred to merely as “inspection apparatus”) 100. The inspection apparatus 100 includes an inspection optical system 1 that irradiates a surface of a subject 2 in a form of a disc such as a magnetic disc, an IC wafer, or the like being a workpiece with an inspection light, a frame 9 that supports the inspection optical system 1 on the apparatus, and a scanning unit 10 that scans the subject 2 so as to scan a whole surface of the subject 2. The inspection apparatus 100 also includes a preprocessing unit 50 that processes an output from the inspection optical system 1, and a data processor 11 that controls the scanning unit 10 and includes a processing unit 12 that inputs the output from the preprocessing unit 50 and processes the data.

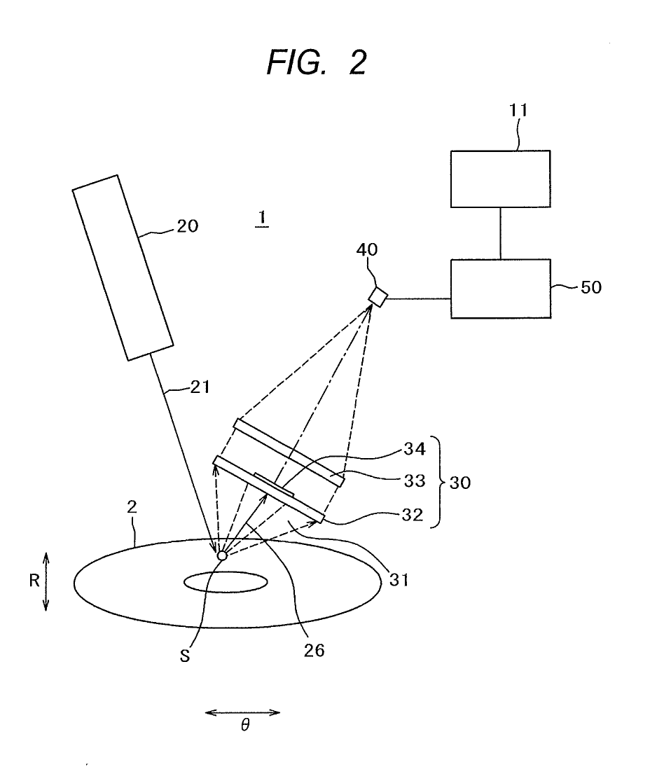

A mechanism and operation of scanning the whole surface of the subject by spirally scanning the doughnut-shaped subject 2 as shown in FIG. 2 is explained below.

A work table 3 is, as shown in FIG. 1, supported by a linear movement table 5 and a 8 rotation table 6. The linear movement table 5 linearly moves in a direction R, and the A rotation table 6 is provided on the linear movement table 5. The θ rotation table 6 is provided with an encoder 6a that generates a signal indicative of a rotation angle, and the linear movement table 5 is provided with an encoder 5a that generates a signal indicative of a movement position in the direction R. The signal from each encoder 5a, 6a is transmitted to a data processor 11 (interface 14) as a scanning position signal.

Denoted by 2a is a sensor detecting that the subject 2 is placed on the work table 3. Denoted by 3a is a guide pin for setting the subject 2 such that the center of the doughnut-shaped subject 2 coincides with the center of rotation of the θ rotation table 6. Denoted by 8 is a θ-direction drive circuit that drives the A rotation table 6, and the rotating direction, the rotating speed, the stopping position and the like of the work table 3 are controlled through the drive circuit. Denoted by 7 is an R-direction drive circuit that linearly moves the linear movement table 5 in the direction R. These drive circuits are controlled in accordance with a control signal from the data processor 11.

By controlling such a mechanism with a constant-speed spiral scanning program 13b stored in a storage unit 13, the subject 2 is spirally scanned. Specifically, the subject 2 is placed such that the center of the subject 2 coincides with the center of rotation of the θ rotation table 6, and an inspection light 21 is set at an inner edge of the doughnut. Subsequently, while rotating the work table 3 at a constant speed by the θ rotation table 6, the work table 3 is moved in the radial (R) direction of the subject 2, for example in the left-to-right direction in FIG. 1, by the linear movement table 5. This allows for scanning, i.e. inspecting, the whole surface of the subject 2 with the inspection light 21.

The scanning is not limited to the spiral shape but may be performed in a rectangular shape, or the scanning may be performed by moving the inspection optical system.

Measured data of the scattered light at each measurement point when the whole surface is scanned is digitally converted by the preprocessing unit 50 and transferred to the data processor 11, and each measurement point (scanning) position specified by each encoder 5a, 6a and the measured value at the point are stored in a measurement result storing area 13c of the storage unit 13. A defect analysis program 13a stored in the storage unit 13 analyzes the data from each measurement point of which position is identified, whereby the defect such as a scratch S or a foreign substance can be inspected for and the result can be displayed on a display device 15. In FIG. 1, denoted by 16 is a bus.

A configuration of the inspection optical system 1 being a feature of the embodiment of the present invention is explained below with reference to FIG. 2. The inspection optical system 1 includes a laser unit (light source) 20 that irradiates the surface of the subject 2 with the laser light 21 and a scattering optical system 30 that forms an image on a light receiving surface of a sensor array 40 with scattered light 31 from among the light reflected by the defect S on the subject 2. An irradiation point in this embodiment is a position offset from the center of the doughnut-shaped subject 2, and the whole surface is scanned by moving the subject 2 in the direction R.

The scattering optical system 30 includes an objective lens 32, a mask 34 that blocks a regular reflected light 26 from among the whole reflected light, and an imaging lens that focuses the scattered light 31, which its regular reflected light 26 has been cut, onto the sensor array 40. A horizontal resolution in an array direction of the light receiving element, i.e. in the horizontal direction with respect to the thickness direction, can be defined by the size of the light receiving element in the array direction/detection magnification of the scattering optical system. For example, assuming here the size of the light receiving element in the array direction as 500 μm and the detection magnification of the scattering optical system as 100, the horizontal resolution is 5 μm. The width of the dead zone is, based on 10% of the width of the light receiving element, 0.5 μm.

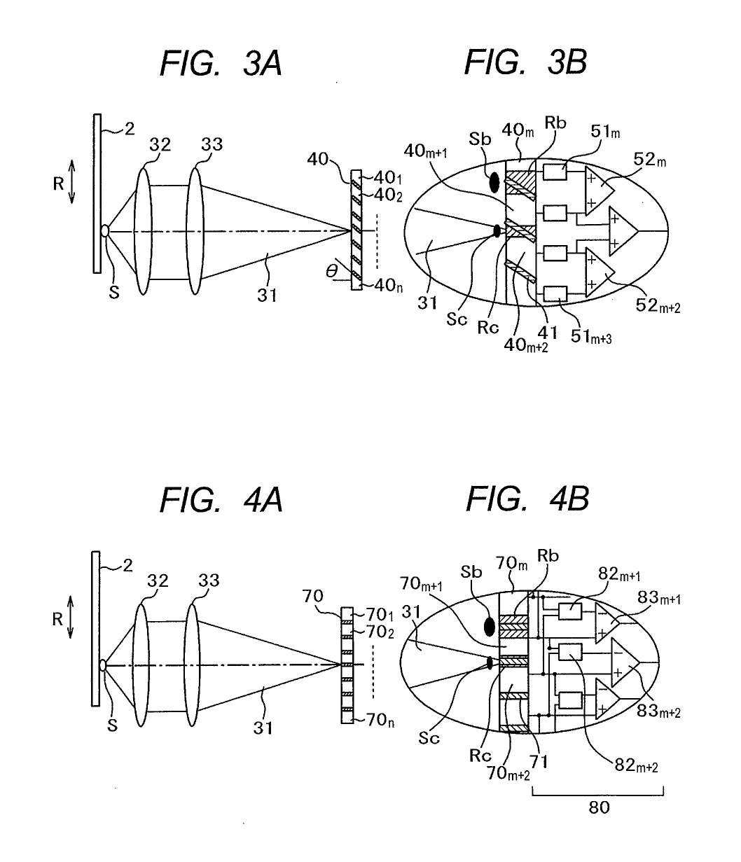

FIGS. 3A and 3B show a configuration of the sensor array 40 according to the embodiment (hereinafter, “the present sensor array”) and a relation between the present sensor array 40 and the subject 2 (FIG. 3A) as well as a configuration of the preprocessing unit 50 of the present sensor array 40 (FIG. 3B). On the other hand, FIGS. 4A and 4B show a configuration of a conventional sensor array (hereinafter, “conv. sensor array”) 70 and a relation between the conv. sensor array 70 and the subject 2 (FIG. 4A) as well as a configuration of a preprocessing unit 80 of the conv. sensor array 70 (FIG. 4B).

The present sensor array 40 and the conv. sensor array 70 include a plural number (n) of light receiving elements 40₁ to 40ₙ, 70₁ to 70ₙ, respectively, and both are arranged in parallel with the subject 2 in the direction R. The conv. sensor array 70 is, as shown in FIG. 4B, provided with a dead zone 71 that is an insulator separating light receiving elements so as to be perpendicular to the array direction of the sensor array 70.

On the other hand, as shown in FIG. 3B, the present sensor array 40 is provided with a dead zone 41 obliquely to the array direction of the sensor array 40, making the structure of the light receiving element rhombic. In this embodiment, the oblique angle θ is 30 degrees. When the oblique angle θ is smaller than 25 degrees, it approaches the conv. sensor array leading to decrease of an effect to be described later, and when it is larger than 45 degrees, the scattered light 31 always extends over the dead zone 41 or even extends over two dead zone 41 in some locations, which is not desirable. Accordingly, the oblique angle θ is preferably in a range of 25 to 45 degrees.

As a result, as shown in FIGS. 3B and 4B, in a case of a defect Sb causing the scattered light 31 extending over the dead zone 41, 71, a detection region Rb indicated by a shadow mark is divided into regions of light receiving elements 40ₘ and 40ₘ₊₁ (m≧1, integer, the same hereinafter) or the light receiving elements 70ₘ and 70ₘ₊₁, respectively, leading to reduction of detection sensitivity.

Especially in a case of a defect Sc with the size equal to or smaller than the width of the dead zone 71, a detection region Rc indicated by a shadow mark is buried in the dead zone 71 of the conv. sensor array 70 at the worst, and an output signal cannot be obtained. For example, if the dead zone is 5 μm, a defect of 0.5 μm or less may not be detected.

On the other hand, with the present sensor array 40, because the dead zone 41 is provided obliquely, the detection region Rc on either side of the dead zone 41 has a region in which the output can be obtained in at least one of the light receiving elements 40ₘ and 40ₘ₊₁. Accordingly, although the detection sensitivity of the present sensor array 40 may be reduced by the amount of the crossing dead zone, the output signal can be obtained.

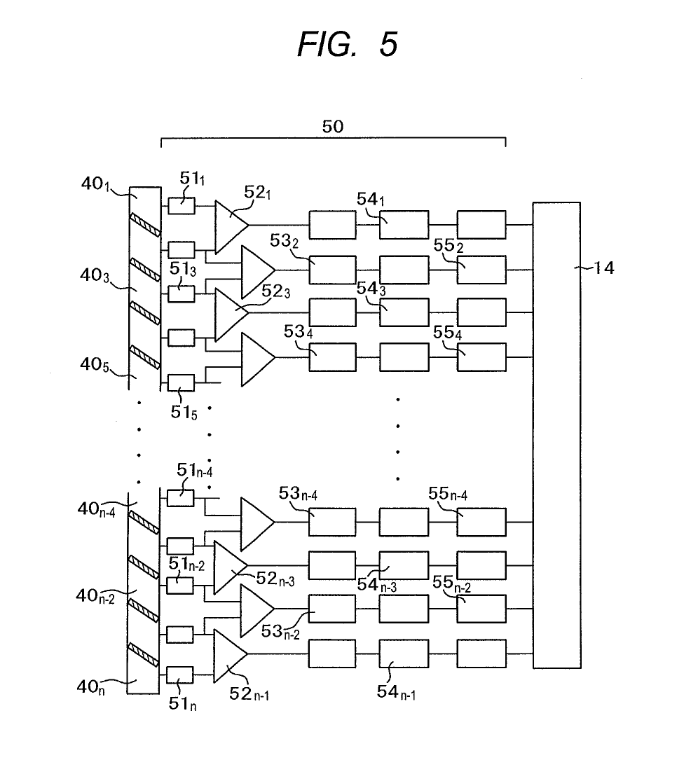

To compensate for the reduction in the detection sensitivity due to the dead zone 41, as shown in FIG. 3B, the embodiment is provided with adders 52 (52₁ to 52ₙ₋₁: see FIG. 5) adding outputs from two adjacent light receiving elements. As a result, the reduction of the detection sensitivity can be suppressed to the amount of the crossing dead zone 41. The influence by the reduction of the light receiving amount can also be reduced.

The effect of providing the adders 52 can also benefit the case of using the conv. sensor array 70. When using the conv. sensor array 70, not much effect is brought about in a case where the detection region Rc is buried in the dead zone 71 at the worst, but the effect similar to that of the present sensor array 40 is brought about in a case where the detection region Rb extends over two light receiving elements 70.

A prior art preprocessing unit 80 shown in FIG. 4B inputs, for example, an output from an average value calculation circuit 82ₘ₊₁ for the outputs from the light receiving elements 70ₘ and 70ₘ₊₂ on both sides of the central light receiving element 70ₘ₊₁ and an output from the central light receiving element 74ₘ₊₁, into a differential amplifier 83ₘ₊₁ to generate an output signal. The prior art processing circuit 80 detects difference in light receiving positions depending on the defect type such as an unevenness and therefore it is suitable for detecting the size and the type of the defect, but may not be very effective in inhibiting the reduction of the detection sensitivity. For example, in the aforementioned case of the defect Sb, taking a comprehensible example in which the outputs from the light receiving elements 70ₘ and 70ₘ₊₁ are equal to Ta and the outputs from the light receiving elements 70ₘ₋₁, 70ₘ₊₁ are zero, the outputs from the average value calculation circuit 82ₘ₊₁ and the differential amplifier 83ₘ₊₁ are both Ta/2, resulting in the reduction of the detection sensitivity.

However, by inputting the output from the adder 52 according to the embodiment to the prior art preprocessing unit 80 as the output from the present sensor array 40 or the conv. sensor array 70, the effect of the prior art is also available.

FIG. 5 shows a general configuration of the preprocessing unit 50 according to the embodiment. The output from each light receiving element 40₁ to 40ₙ is input to each current/voltage converter 51 (51₁ to 51ₙ) that converts the output current to a voltage. The outputs from two adjacent current/voltage converters 51, such as the current/voltage converter 51₁ and 51₂, are input to the adder 52₁ described above. The output from the adder 52₁ is, to reduce noise, passed through a high frequency cut filter 53₁ and low frequency cut filter 54₁, converted to a digital signal by an A/D converter 55₁, and introduced into the data processor 11 shown in FIG. 1 via the interface 14.

The adder may be a summing amplifier. The signal from each of the light receiving elements 40₁ to 40ₙ may be amplified and then A/D converted, and the subsequent post-processing may be performed by the processing unit 12. Furthermore, both the A/D conversion and the processing corresponding to the preprocessing unit 80 may be performed by the processing unit 12.

As already described with reference to FIG. 1, with the aid of the defect analysis program 13a stored in the storage unit 13, the data of each measurement point of which position is identified can be analyzed, an inspection of the defect S such as the scratch or the foreign substance can be performed, and the result can be displayed on the display device 15.

According to the embodiment described above, it is possible to provide the optical surface defect inspection apparatus or the optical surface defect inspection method that reduces the influence from the dead zone of the sensor array and enables the defect inspection with high sensitivity.

What is claimed is:

1. An optical surface defect inspection apparatus including:
an irradiation means irradiating a subject with an inspection light;
a sensor array including light receiving elements separated by dead zones insensitive to light scattered by a surface of the subject and arranged in a line;
a scattering optical means light focusing the scattered light onto the sensor array;
a plurality of addition means adding outputs from two adjacent the light receiving elements; and
a processing unit inspecting for a defect on the surface of the subject based on outputs from the addition means.

2. The optical surface defect inspection apparatus according to claim 1, wherein
the sensor array has the dead zone arranged at an oblique angle with respect to a direction perpendicular to the line.

3. The optical surface defect inspection apparatus according to claim 2, wherein
the oblique angle is in a range of 25 to 45 degrees.

4. The optical surface defect inspection apparatus according to claim 1, including:
a first addition means as one of the plurality of the addition means;
an average value calculation means calculating an average of outputs from two second addition means adjacent to the first addition means;
an output difference calculation means obtaining an output difference between the first addition means and the average value calculation means; and
the processing unit inspecting the defect on the surface of the subject based on the output from the output difference calculation means.

5. The optical surface defect inspection apparatus according to claim 1, wherein
the subject is a magnetic disc or an IC wafer in a form of a disc, and the apparatus further includes a scanning means two-dimensionally scanning the inspection light on the surface of the subject the inspection light.

6. An optical surface defect inspection method including:
an irradiation step of irradiating a subject with an inspection light;
a step of forming an image on a sensor array including light receiving elements separated by dead zones insensitive to light scattered by a surface of the subject, the receiving elements being arranged in a line;
a plurality of addition steps of adding outputs from two adjacent light receiving elements; and
a processing step of inspecting for a defect on the surface of the subject based on the result of the addition step.

7. The optical surface defect inspection method according to claim 6, wherein
the sensor array has the dead zone arranged at an oblique angle with respect to a direction perpendicular to the line.

8. The optical surface defect inspection method according to claim 6, including:
an average value calculation step of calculating an average of outputs of two second addition steps adjacent to a first addition step as one of the plurality of the addition steps;
an output difference calculation step of obtaining an output difference between the first addition step and the average value calculation step; and
the processing step of inspecting for the defect on the surface of the subject based on the output of the output difference calculation step.
